(19) United States
(12) Patent Application Publication
(10) Pub. No.: US 2026/0219924 A1
(43) Pub. Date: Jul. 30, 2026

(54) SYSTEMS AND METHODS FOR DISPATCHING CHANGE EVENTS USING PRIORITIZED QUEUES

(71) Applicant: SHOPIFY INC., Ottawa (CA)

(72) Inventors: Koen Bouwmans, Victoria (CA); Wiliam Oliveira, Barcelona (ES); Zachary Reyno-Chiasson, Terence Bay (CA)

(21) Appl. No.: 19/041,171

(22) Filed: Jan. 30, 2025

(51) Int. Cl. G06F 9/48

(52) U.S. Cl. CPC G06F 9/4881

(57) ABSTRACT

Systems and methods for the automatic dispatching of change events in an event-driven system are described. In examples, a change event dispatcher module may receive an indication of a change event associated with a data source in a distributed network, the change event being generated by an event producer in an event-driven system. The change event dispatcher module may determine a corresponding priority level for the received indication, based on a priority function and may dispatch the received indication for processing by one or more event consumers in the event-driven system, based on the priority level, to cause the one or more event consumers to perform one or more data actions. The disclosed systems and methods enable messages associated with high priority changes to be retrieved from a corresponding message queue by event consumers and processed more quickly than lower priority messages.

### FIELD

The present disclosure relates to event-driven systems, in particular to processing change events in an event-driven system, and more particularly, to systems and methods for dispatching change events for processing in an event-driven system using prioritized queues.

### BACKGROUND

In an event-driven system, different system modules (also referred to as event producers or publishers) may generate system events (also referred to simply as events). Other software functions or modules, which may be referred to as event consumers, are tasked with processing (also referred to as consuming) events as the events occur.

### SUMMARY

Change Data Capture (CDC) is a technique used to monitor source data in real-time or near-real-time, for identifying changes in the source data (e.g., known as change events or deltas) and propagating these changes across distributed systems. For example, a change event detection system using CDC approaches is commonly used in data warehousing applications, where the change event detection system may track modifications in transaction logs associated with a source database (e.g., including Create-Read-Update-Delete (CRUD) operations, among other possibilities) and may make these changes available to other systems as a stream of change events.

In a typical event-driven system, events (such as change events, or other occurrences of interest to the system) can be generated by event producers at any time, and event consumers can process these events as they occur. An indication of an event (also referred to as an event message, or a message) is a data object that contains information about the event. For example, an indication of an event may include a request to be executed by a service (e.g., an event consumer), for example, to cause the event consumer to perform a corresponding data action.

Event-driven systems may include an event router (also referred to as an event broker) to connect the event producers and the event consumers, for example, for integrating the event producers and event consumers as in a publisher/subscriber framework, or in an event streaming model. A challenge occurs during periods of high event volume, where event processing may be slow and subject to bottlenecks and delays. For example, sudden and/or rapid bursts in change event detection (and hence, event generation) may overwhelm an event-driven system, for example, causing lags in execution, while the system works through the influx of events. In some cases, resource capacity associated with computing devices in the event-driven system can be increased or otherwise adapted to address such fluctuations in demand, for example, separate clusters may be used for different services, or overall resource capacity may be scaled up responsive to the increased computational needs (e.g., associated with processing bursts of events). However, delays may still be experienced while resource capacity is ramping up. Furthermore, the act of adding more resources to compensate for such delays is not resource or computationally efficient.

In various examples, the present disclosure describes systems and methods for optimizing the real-time performance of event-driven systems, based on determined event priority levels. A CDC framework is used to detect and capture changes in a data store. In some embodiments, for example, changes may be reflected in a database table (such as a MySQL table, among other possibilities) and a topic may exist for each MySQL table being monitored (or from which updates are being consumed). In examples, a change event dispatching system receives indications of the change events (e.g., from one or more topics) and for each topic, dispatches the indications into a set of queues, based on respective priority levels of the indications. In this regard, the event-driven system may be optimized by splitting streams of event indications (e.g., being consumed from a single topic) into various queues for processing over different time frames, thereby enabling the most important events associated with a single topic to be addressed quickly (e.g., in real-time or near-real-time).

Advantageously, the present disclosure recognizes that inflexibility in current event-driven systems can cause delays in real-time processing, for example, when lower priority events are unnecessarily processed in real-time while occupying valuable computing resources that could be directed toward processing higher priority events. For example, in conventional event-driven systems, while each topic may be handled differently (e.g., different topics may be consumed or handled with different priorities), indications of events consumed from a single topic may typically be retrieved for processing in the order in which they were consumed (e.g., consumed from a message queue chronologically). In some cases, it is important to process ordered event indications chronologically, for example, to preserve dependencies between events. However, in other cases (e.g., when it is important that certain event indications (within a single topic) be processed more quickly than other event indications (e.g., within the same topic), a conventional message queue does not overcome the challenges described above. The present disclosure provides a technical advantage of distinguishing a priority level of an indication of an event, where the priority level may inform how the indication is processed by the one or more event consumers. In this regard, indications of events requiring real-time processing (and hence having a higher priority level than other events within the same topic) may be processed more quickly, or otherwise handled differently, than indications of events having a lower priority level, for example, which may not require real-time processing. Therefore, in some situations, enabling options for out-of-order processing based on a priority level of the indication of an event may improve the performance of event-driven systems.

Examples of the disclosed solution may provide a technical advantage of improving processing times and reducing delays and/or backlogs in event processing. In the present disclosure, an indication of an event may be processed differently depending on which one of the plurality of priority queues the indication is dispatched into. For example, event indications associated with the lowest priority changes may be dispatched into a non-priority queue (e.g., a no-operation queue), which may be associated with a scheduled batch process while indications associated with low, medium or high priority changes may be dispatched into various real-time processing queues (e.g., having different service level objectives (SLOs) for processing times, among other possibilities). The disclosed solution may improve the real-time performance of event-driven systems, by routing the lowest priority event indications to scheduled batch processes and ensuring that higher priority event indications are addressed more quickly (e.g., in real-time or near-real-time).

Advantageously, examples of the disclosed solution may make efficient use of computational and other resources (e.g., processing power, memory, computing time, etc.) associated with periods of high event generation (e.g., bursts of events). For example, during periods of high event volume, the resources associated with event consumers may dynamically scale between minimum and maximum resource limits to respond to fluctuations in demand. In examples, event consumers tasked with processing higher priority event indications may have a higher maximum resource limit than event consumers tasked with processing lower priority event indications. Similarly, event consumers tasked with processing lower priority event indications may have a minimum resource limit that is lower than event consumers tasked with processing higher priority event indications. In this regard, the proposed solution may benefit from greater flexibility in managing the computing resources, thereby ensuring the efficient use of computing resources and improving the performance of event-driven systems, particularly in conditions of high event generation.

In some examples, the present disclosure describes a change event dispatching system comprising: one or more processor devices; and one or more memories storing machine-executable instructions, which when executed by the one or more processor devices, cause the change event dispatching system to execute operations of a change event dispatcher module, the change event dispatcher module being configured to: receive an indication of a change event associated with a data source in a distributed network, the change event being generated by a computing device associated with an event producer in the distributed network; determine a corresponding priority level for the received indication, based on a priority function; and dispatch the received indication for processing by one or more computing devices associated with one or more event consumers in the distributed network, based on the priority level, to cause the one or more computing devices associated with one or more event consumers to perform one or more data actions corresponding to the indication.

In an example of the preceding example aspect of the system, wherein the change event dispatching system further comprises the computing device associated with the event producer and the one or more computing devices associated with the one or more event consumers.

In an example of a preceding example aspect of the system, further comprising: a plurality of priority queues, wherein the change event dispatcher module is configured to dispatch the received indication to one of the plurality of priority queues, based on the priority level, and wherein the received indication is processed differently by the one or more event consumers, depending on which one of the plurality of priority queues the indication is dispatched into.

In an example of a preceding example aspect of the system, wherein the change event dispatcher module is further configured to: select a respective one of the plurality of priority queues for dispatching the received indication, based on the respective priority level.

In an example of a preceding example aspect of the system, wherein at least one of the plurality of priority queues is associated with a target processing timeframe for real-time or near real-time processing.

In an example of a preceding example aspect of the system, further comprising: a non-priority queue, wherein the change event dispatcher module is configured to dispatch the received indication to the non-priority queue, based on the priority level, for processing by the one or more computing devices associated with the one or more event consumers.

In an example of the preceding example aspect of the system, wherein the non-priority queue is associated with a scheduled batch process.

In an example of a preceding example aspect of the system, wherein the change event dispatcher module is further configured to: write the received indication to an intermediate data store.

In an example of the preceding example aspect of the system, wherein the change event dispatcher module is configured to determine the priority level for the received indication by: obtaining change event information for the received indication; and determining the priority level, based on the change event information and the priority function, wherein the priority function identifies a processing logic for determining the priority level.

In an example of the preceding example aspect of the system, wherein the change event information is selected from a group consisting of: a source field of the received indication, an ID field of the received indication, one or more characteristics of the change event, and a predicted downstream processing load associated with processing the received indication.

In an example of a preceding example aspect of the system, wherein the one or more data actions correspond to an indexing process, and the one or more event consumers includes a real-time indexer or a batch indexer.

In an example of a preceding example aspect of the system, wherein the change event dispatcher module is further configured to: dynamically adjust computing resources allocated to the one or more devices associated with the one or more event consumers, based on the dispatching, to cause a more efficient operation of the change event dispatching system within a consistent overall resource capacity.

In some examples, the present disclosure describes a computer-implemented method for processing change events. The method includes a number of steps, including: receiving, into a processing pipeline, an indication of a change event associated with a data source in a distributed network, the change event being generated by a computing device associated with an event producer in the distributed network; determining a priority level for the received indication, based on a priority function; queueing the received indication, based on the priority level; and transmitting the received indication to one or more computing devices associated with one or more event consumers for processing the received indication, according to the priority level, to cause the one or more computing devices associated with one or more event consumers to perform one or more data actions associated with the received indication.

In an example of the preceding example aspect of the method, wherein queueing the received indication comprises: dispatching the received indication to a respective one of a plurality of priority queues, based on the priority level, wherein the received indication is processed differently by the one or more event consumers, depending on which one of the plurality of priority queues the indication is dispatched into.

In an example of the preceding example aspect of the method, wherein at least one of the plurality of priority queues is associated with a target processing timeframe for real-time or near real-time processing.

In an example of a preceding example aspect of the method, wherein queueing the received indication comprises: dispatching the received indication to a non-priority queue, based on the priority level, for processing by the one or more computing devices associated with the one or more event consumers.

In an example of the preceding example aspect of the method, wherein the non-priority queue is associated with a scheduled batch process.

In an example of a preceding example aspect of the method, wherein determining the priority level for the received indication comprises: obtaining change event information for the received indication; and determining the priority level, based on the change event information and the priority function, wherein the priority function identifies a processing logic for determining the priority level.

In an example of a preceding example aspect of the method, further comprising: dynamically adjusting computing resources allocated to the one or more computing devices associated with the one or more event consumers, based on the dispatching, to cause the one or more computing devices associated with the one or more event consumers to process the received indication more efficiently within a consistent overall resource capacity.

In some examples, the present disclosure describes a non-transitory computer readable medium storing instructions that, when executed by a processing unit of a computing system, cause the computing system to: determine a priority level for a received indication of a change event associated with a data source in a distributed network, based on a priority function, the change event being generated by a computing device associated with an event producer in the distributed network; queue the received indication, based on the priority level; and transmit the received indication to one or more computing devices associated with one or more event consumers for processing the received indication, according to the priority level, to cause the one or more computing devices associated with one or more event consumers to perform one or more data actions associated with the received indication.

### BRIEF DESCRIPTION OF THE DRAWINGS

Reference will now be made, by way of example, to the accompanying drawings which show example embodiments of the present application, and in which:

FIG. 1 is a block diagram illustrating an exemplary simplified system in which exemplary embodiments of the present disclosure may be implemented;

FIG. 2 is a block diagram of an example computing system, which may be used to implement examples of the present disclosure;

FIG. 3 shows a block diagram of an example architecture for a change event dispatching system, in accordance with example embodiments of the present disclosure;

FIG. 4 shows a block diagram of an example architecture for a change event dispatcher module of the change event dispatching system of FIG. 3, in accordance with example embodiments of the present disclosure; and

FIG. 5 is a flowchart illustrating an example computer-implemented method for processing change events within an event-driven system, in accordance with examples of the present disclosure.

Similar reference numerals may have been used in different figures to denote similar components.

### DETAILED DESCRIPTION

In various examples, systems and methods for the automatic dispatching of change events in an event-driven system are described. In examples, a change event dispatcher module may receive an indication of a change event associated with a data source in a distributed network, the change event being generated by an event producer in an event-driven system. The change event dispatcher module may determine a corresponding priority level for the received indication, based on a priority function and may dispatch the received indication for processing by one or more event consumers in the event-driven system, based on the priority level, to cause the one or more event consumers to perform one or more data actions. The disclosed systems and methods enable messages associated with high priority changes to be retrieved from a corresponding priority queue by event consumers and processed more quickly than lower priority messages.

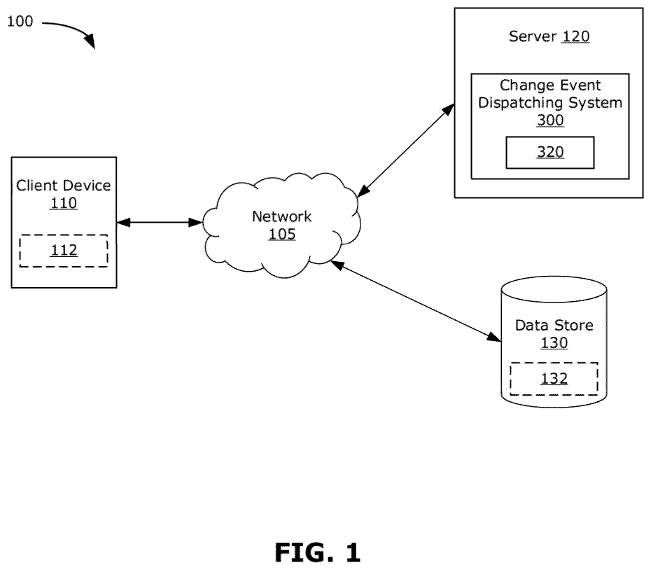

FIG. 1 is a block diagram illustrating an exemplary simplified system 100 in which exemplary embodiments of the present disclosure may be implemented. The system 100 has been simplified in this example for ease of understanding. Generally, there may be more entities and components in the system 100 than that shown in FIG. 1. The system 100 may be an integrated system for communicating across a distributed network. The system 100 may include a data communications network 105. The data communications network 105 may be any form of data communications network (e.g., an intranet, the Internet, a P2P network, a WAN and/or a LAN, among other possibilities). The system 100 may further include one or more client devices 110, one or more servers 120 and a data store 130. In examples, the data store 130 may be a database or a distributed storage or data repository, for example, a cloud-based storage or data repository, for example, for storing large volumes of data (e.g., current or historical data). Although the server 120 and the data store 130 are shown as separate components, it is understood that the server 120 and the data store 130 could be embodied in a single component, such as a cloud environment, among other possibilities. Similarly, the data store 130 may be embodied within the client device 110, among other possibilities.

In examples, a user may interact with the system 100 via the client device 110, for example, using a client application 112 (e.g., a web browser, or another application). In examples, the client device 110 may connect to the network 105 in order to communicate with the server 120, as described herein. In other examples, embodiments of the present disclosure may be implemented on a single client device 110 without communicating with the server 120 over the network 105. In examples, the client device 110 can be a desktop computer, a laptop computer, a mobile communication device (such as a smart phone or a tablet), a wearable device (such as a smart watch or VR headset), or any other suitable computing device that can perform the functionality described herein.

The term “server”, as used herein, is not intended to be limited to a single hardware device. For example, the server 120 may include a server device, a distributed computing system, a virtual machine running on an infrastructure of a data center, or infrastructure (e.g., virtual machines) provided as a service by a cloud service provider, among other possibilities. Generally, the server 120 may be implemented using any suitable combination of hardware and software, and may be embodied as a single physical apparatus (e.g., a server device) or as a plurality of physical apparatuses (e.g., multiple machines sharing pooled resources such as in the case of a cloud service provider). The term “resources”, as used herein, can refer to hardware or software elements, for example, physical hardware infrastructure or virtual infrastructure. By way of example, resource capacity may be expressed in terms of processing power or bandwidth, memory, storage space, computing time, etc.

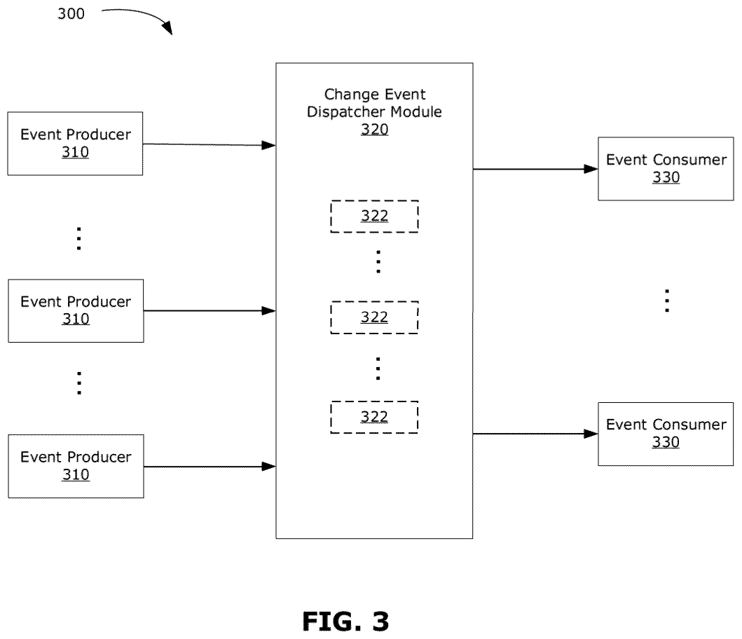

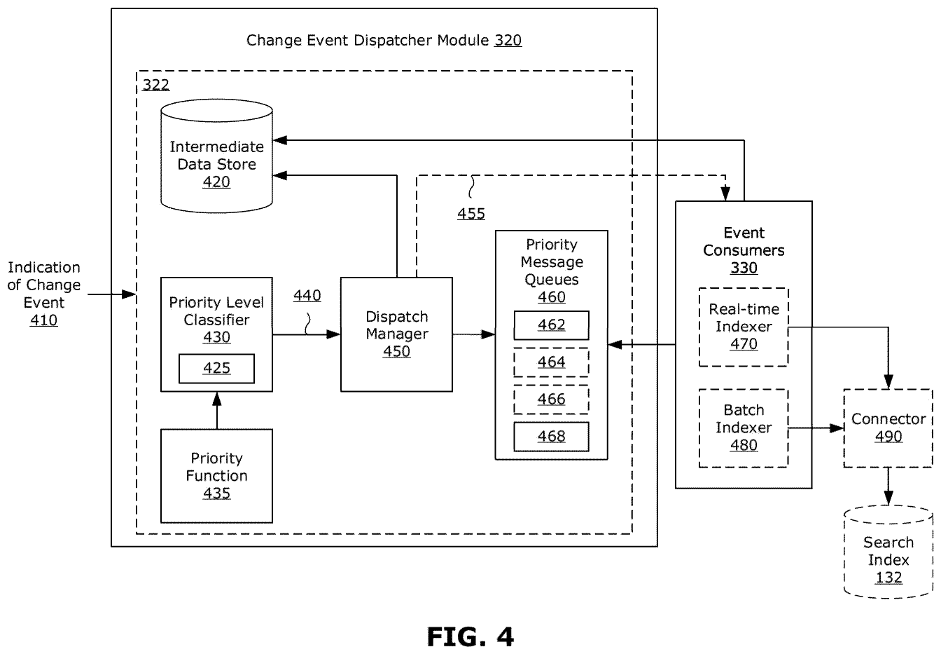

In examples, the server 120 may include an event-driven system, for example, and a change event dispatching system 300 (e.g., described in more detail with respect to FIG. 3 and FIG. 4), for example, for dispatching one or more change events for processing by one or more event consumers (not shown) of the system 300. In some embodiments, for example, the one or more event consumers may represent an indexing service, for example, a real-time indexer or a batch indexer, for maintaining and/or updating a search index 132 associated with a search engine. In some examples, a search index 132 associated with the search engine may be a database stored in the data store 130, for example, where the search index 132 is database that is designed for speed of searching current data rather than a permanent storage of historical data. In examples, the search index 132 may store and organize information using keywords or other metadata found in records and documents to facilitate search performance of the search engine. For example, a user may enter a text string or another input into an application user interface (UI) to perform a search using the search engine, or the search index 132 and search engine may be used for generating suggestions for providing to the user, for example, a listing of similar items or pages associated with a category or a “collection” of objects which have been grouped based on some measure of similarity, for example, that may be generated programmatically (i.e. not by the user), among other possibilities. In some cases, certain events associated with changes to such a “collection” of objects may inherently be higher priority events and may be required to be reflected in updates to the search index 132 faster than other events.

In examples, a user's interaction with the client application 112 (e.g., a search engine UI, or web browser, among other possibilities) may generate event data that may be processed using the change event dispatching system 300, for example, for updating a search index 132, among other possibilities. In other examples, event data may be generated independent of the user.

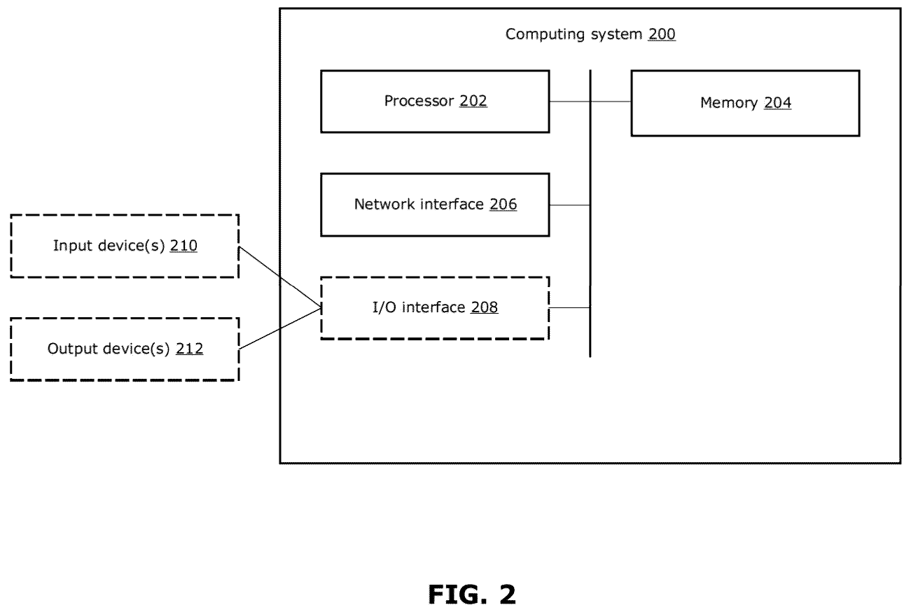

FIG. 2 illustrates an example computing system 200, which may be used to implement examples of the present disclosure. For example, the computing system 200 may be used to implement processes of the change event dispatcher module 320 and/or the change event dispatching system 300, as disclosed herein.

The example computing system 200 includes at least one processor 202 and at least one physical memory 204. The processor 202 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 204 may include a volatile or non-volatile memory (e.g., a flash memory, a random access memory (RAM), and/or a read-only memory (ROM)). The memory 204 may store instructions for execution by the processor 202, to enable the change event dispatcher module 320 (e.g., described with respect to FIG. 4 below), which is implemented by the computing system 200, to carry out examples of the methods, functionalities, systems and modules disclosed herein. The memory 204 may include other software instructions, such as for implementing an operating system and other applications/functions. The memory 204 may also include data 214, such as data stored in a local cache, etc. In some examples, the intermediate data store 420 may be implemented using the physical memory 204; in other examples, the intermediate data store 420 may be implemented using an external physical memory that is in communication with the computing system 200.

The computing system 200 may also include at least one network interface 206 for wired and/or wireless communications with an external system and/or network (e.g., an intranet, the Internet, a P2P network, a WAN and/or a LAN). A network interface may enable the change event dispatcher module 320 to carry out communications (e.g., wireless communications) with systems external to the change event dispatching system 300. In some examples, the change event dispatcher module 320 may use the network interface to communicate with one or more event producers 310 and/or one or more event consumers 330 (e.g., in the case where the change event dispatching system 300 is a distributed system).

The computing system 200 may optionally include at least one input/output (I/O) interface 208, which may interface with optional input device(s) 210 and/or optional output device(s) 212. Input device(s) 210 may include, for example, buttons, a microphone, a touchscreen, a keyboard, etc. Output device(s) 212 may include, for example, a display, a speaker, etc. In this example, optional input device(s) 210 and optional output device(s) 212 are shown external to the computing system 200. In other examples, one or more of the input device(s) 210 and/or output device(s) 212 may be an internal component of the computing system 200.

In some examples, the computing system 200 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the computing system 200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the computing system 200 may communicate with each other via a bus, for example.

As will be discussed further below, the present disclosure describes an example change event dispatching system 300 that enables the dispatching of a received indication of a change event to a plurality of priority queues, for processing by one or more event consumers, based on a priority level of the indication.

FIG. 3 illustrates an example of the change event dispatching system 300, in accordance with some examples of the present disclosure. The change event dispatching system 300 includes one or more event producers 310, a change event dispatcher module 320 and one or more event consumers 330. The change event dispatching system 300 may be a distributed system, in which events are used to coordinate operations among disparate machines, subsystems or modules of the distributed system.

An event may contain information about an occurrence external to the system 300 (e.g., caused by a user input, third party etc.) or an occurrence internal to the system 300 (e.g., a change of state of a module of the system 300). An indication of an event (also referred to as an event message or simply a message) is a data object that contains information about the occurrence. For example, an event indication may include a header and a payload including information or metadata about the event (e.g., including a request to be executed by a consumer 330, among other possibilities). In the example shown, the change event dispatching system 300 includes a plurality of event producers 310 (also referred to as publishers). Each event producer 310 may be, for example, a function or software module of the system 300 that generates respective indications of events (e.g., associated with change events). In examples, based on a publisher/subscriber model, the event producers 310 may publish event indications to various topics. For example, a topic may represent a specific category of information communicated between event producers 310 and event consumers 330 (also referred to as subscribers) in the publisher/subscriber model. In examples, event consumers 330 may subscribe to topics (e.g., in the publisher/subscriber model) or filter event indications based on properties in the message payload.

In examples, an event associated with a data source external to the system 300 using CDC approaches may represent a modification in a transaction log associated with a source database, for example, responsive to CRUD operations, among other possibilities. For example, such occurrences external to the system 300 may be associated with a user input and can include: a user-initiated update via a user interface (UI), for example, updates to website content (e.g., publishing new content, editing existing content, deleting content etc.), that causes the removal or deletion of one or more data entries in a database (e.g., associated with data store 130, or another data store, among other possibilities), updates to a website that are associated with a calendar event or date entry, moderating or approving comments associated with a webpage, etc.

In some embodiments, for example, an occurrence (e.g., a change event) external to the system 300 may be associated with a single user-initiated action but may cause the generation and/or execution of multiple subsequent events (e.g., occurring as a burst of change events generated during a short time frame, among other possibilities). In this regard, a single originating user action (e.g., causing an originating event to be generated) may cause the system 300 to incur greater downstream processing load, for example, for processing the burst of subsequent events. For example, such user-initiated actions can include: a user-initiated update via a user interface (UI), for example, that causes the removal or deletion of one or more data entries in a database (e.g., decommissioning a website causes the removal of a volume of entries in a corresponding search index), or that causes the addition, activation or updating of one or more data entries in the database (e.g., activating a website causes the addition of a volume of entries in a corresponding search index); disabling or enabling a geographic locale associated with a multilingual website for (e.g., where deactivating or activating an automatic text translation may cause the removal or addition of a volume of web content and corresponding updates to the search index), among other possibilities. Examples of occurrences internal to the system 300 (e.g., a change of state of a module of the system 300) can include: CDC backfill events; system maintenance events; system-driven events such as purging of information; bulk operations or other regularly scheduled batch processing, among other possibilities.

In a conventional event-driven system, the event router may be a software module that performs operations to connect event producers and event consumers, for example, where the event-driven system may notify the event consumers when a new indication of an event arrives (e.g., when new indications have been published to specific topics). For example, event producers may generate event indications (e.g., messages) with details about the events and the event router may temporarily store the messages (e.g., in a message queue, among other possibilities) until the event consumers can retrieve them.

In accordance with the present disclosure, a change event dispatcher module 320 may be a software module of the change event dispatching system 300, for example, that represents an improvement over a conventional event router. Optionally, the change event dispatcher module 320 may be configured to include multiple processing pipelines 322, for example, where each pipeline 322 is configured to monitor (or subscribe to) particular topics and connect certain event producers 310 with certain event consumers 330. For example, event indications (e.g., associated with a single topic) may be routed between event producers 310 and event consumers 330 using the processing pipelines 322, where the processing pipelines 322 represent an event store or a message queueing system (e.g., Apache Kafka®, among other possibilities), an event streaming platform (e.g., that is optimized for ingesting and processing streaming data in real-time), or simply a network pipe, among other possibilities.

The event consumers 330 may be algorithms or software modules that process event indications to perform some function of the system 300, for example, to cause one or more data actions to be performed based on instructions or requests included in the event indications. Each event consumer 330 may be subscribed to a particular topic and may pull or retrieve event indications from one or more prioritized queues for processing. In some embodiments, for example, the one or more prioritized queues may represent one or more priority message queues 460, where the received indications represent event messages, as described below with respect to FIG. 4. Although referred to as priority message queues 460, it should be understood that the queues 460 may be used for queueing received indications of change event 410 in general, and are not necessarily limited to event messages.

In some examples, the change event dispatching system 300 may be a distributed system. In such examples, one or more event producers 310 and/or one or more event consumers 330 may be physical machines (e.g., computing stations, sensors, Internet of Things (IoT) devices, etc.) that are physically separate from the change event dispatcher module 320. For example, the change event dispatching system 300 may be implemented over a network (e.g., a virtual private network (VPN) or intranet) and the event producers 310, change event dispatcher module 320 and event consumers 330 may be separate physical machines that communicate over the network. In examples, the change event dispatching system 300 may be implemented using one or more computing systems. In particular, at least the change event dispatcher module 320 may be implemented using a computing system 200, such as a server 120 or another central computing station. In examples, event data may be transferred across the system 300 (e.g., between event producers 310 and event consumers 330) using a communications protocol, such as Transmission Control Protocol (TCP) or User Datagram Protocol (UDP), among other possibilities.

FIG. 4 shows a block diagram of an example architecture for the change event dispatcher module 320, in accordance with examples of the present disclosure. The change event dispatcher module 320 may be a software that is implemented in the computing system 200 of FIG. 2, in which the processor 202 is configured to execute instructions of the change event dispatcher module 320 stored in the memory 204. The change event dispatcher module 320 may receive an indication of a change event 410 and may be configured to dispatch the received indication 410 into one or more priority message queues 460 for processing by one or more of the event consumers 330 (e.g., in real-time, near real-time, among other processing timeframes). In examples, the change event dispatcher module 320 may include one or more processing pipelines 322, where each processing pipeline 322 can include an intermediate data store 420, a priority level classifier 430, a priority function 435, a dispatch manager 450 and the priority message queues 460.

In some embodiments, for example, the indication of the change event 410 may be received by one of the processing pipelines 322. In examples, the received indication 410 may represent a Kafka® record or another type of event message or change event notification. In examples, the received indication 410 can include a header, a key, a value and a timestamp which can be read by the event consumers 330 in order to cause the consumers 330 to perform actions based on the event data.

In examples, responsive to the processing pipeline 322 receiving the change event indication 410, the priority level classifier 430 may obtain change event information 425 associated with the indication 410, for use in determining the corresponding priority level 440 for the received indication 410. In some embodiments, for example, the change event information 425 may be contained in various fields of the received indication 410 (e.g., based on a schema of the indication 410), such as a source field of the received indication 410, for example, identifying the source of the event data (e.g., the producer that generated the event data), or an identification (ID) field of an entity associated with the change event (e.g., an account ID, company name, user name etc.) or a timestamp of the change event, among other possibilities.

In some embodiments, for example, the change event information 425 may represent one or more characteristics of the change event, for example, a type of change event (e.g., creation of a new data record, deletion of a data record, updates to a data record, mergers of data records etc.), an intended destination of the indication 410 (e.g., the consumer 330 that will process the indication 410), a size of an entity and/or data store associated with the change event (e.g., the number of data records associated with the entity and/or data store, such as a large website including thousands of pages, or a large catalog including thousands of records, among other possibilities), or a state of an entity associated with the change event, among other possibilities. In some examples, the query may not need to return a final number of records to determine the size of the entity and/or data store, for example, a query may simply determine whether the number of data records exceeds a threshold value (e.g., 100, 1000), among other possibilities. In some embodiments, for example, the change event dispatcher module 320 may query the data store 130 to retrieve the one or more characteristics of the change event.

In some examples, the one or more characteristics of the change event may be determined based on an ID field of the indication 410, or another field. For example, an explicit list of ID-characteristic pairs, such as ID-Entity_Size (e.g., as a list of IDs associated with entities having large data stores) or ID-Entity_State (e.g., as a list of IDs associated with a state of the entity), among other possibilities, may be available to the priority level classifier 430 for use in determining the priority level 440 for the indication 410. In this regard, the change event dispatcher module 320 may not need to query the data store 130 to obtain such characteristics of the change event.

In other examples, the change event information 425 may represent a predicted downstream processing load (e.g., associated with a number of data records that will be affected by processing the indication 410), for example, when a single change event causes a burst of subsequent events or a large number of data actions to be performed by the event consumers 330, thereby consuming increased processing resources (e.g., processing power, memory, computing time, etc.) of the system 300. For example, for a change event associated with activating a website (e.g., changing a state of the website from inactive to active), the single change event results in many data actions being applied to a large volume of data records (e.g., changing a page status from inactive to active for each page associated with the website, or changing a URL associated with each page, among other possibilities), resulting in the consumption of increased computing resources and potentially introducing backlogs and/or processing delays.

In examples, the priority level classifier 430 may determine the priority level 440 for the indication 410 based on the change event information 425 and a priority function 435. In examples, the priority function 435 may be a pre-determined priority function, for example, the priority function 435 may be selected from a plurality of priority functions by the priority level classifier 430, based on the change event information 425, or the priority function 435 may be associated with the processing pipeline 322, for example, the priority function 435 may be specific to the processing pipeline 322 and may depend on features of the received indication 410, for example, whether the received indication 410 represents changes to items, item variants, meta fields, translations, options etc.

In some embodiments, for example, the priority level classifier 430 may classify the indication 410 according to a classification scheme, where the change event information 425 and/or the priority function 435 may inform the classification scheme. In some embodiments, for example, the priority level classifier 430 may not inform the classification scheme and the priority level classifier 430 may apply the priority function 435 for determining the priority level 440, after classifying the indication 410 according to the classification scheme. In examples, the priority function 435 may represent a processing logic, for example, used by the priority level classifier 430, for determining the corresponding priority level 440 for the indication 410. In this regard, the change event dispatcher module 320 may apply the processing logic and/or the classification scheme to separate a plurality of incoming change event indications into groups of prioritized events according to a corresponding priority level 440, and then may dispatch the prioritized events into corresponding message queues for processing by one or more event consumers 330.

In some embodiments, for example, the priority level classifier 430 may determine the priority level 440 for the indication 410 based on the source field of the indication 410, for example, where certain priority levels 440 (e.g., “high”, “medium”, “low”, “non-priority”, etc.) are associated with indications 410 generated by certain event producers 310 compared to indications 410 originating from other producers 310.

In some embodiments, for example, the priority level classifier 430 may determine the priority level 440 based on the predicted downstream processing load associated with the indication 410 (e.g., a number of subsequent events generated or downstream data actions that will be propagated or executed as a result of processing the indication 410). For example, a “low” priority level 440 may be associated with an indication 410 that causes the updating of more than a threshold value of data records in a data store, whereas a “medium” priority level 440 may be associated with an indication 410 that causes the updating of less than a threshold value of data records in a data store. In an example embodiment, a priority function 435 may specify that an indication 410 that causes the updating of more than a threshold value of data records (e.g., greater than 1000 data records, among other possibilities) is assigned a “low” priority level 440, with effect that the processing of the greater than 1000 data records is executed differently (e.g., according to a different SLO, such as a slower real-time processing timeframe, or using computing resources that have been resourced to reflect the “low” priority level, among other possibilities) than the processing of other indications 410 that may be considered higher priority (e.g., which do not cause the updating of more than a threshold value of data records, among other possibilities). In this regard, the processing of a burst of events is managed to avoid undue processing delays and/or bottlenecks that may otherwise negatively impact the processing of other indications 410 that are considered higher priority.

In some embodiments, for example, the priority level classifier 430 may determine the priority level 440 for the indication 410 based on the type of change event. For example, a “high” priority level 440 may be associated with an indication 410 associated with creation or updating type events (e.g., the publishing of new content, or the editing of existing content, for example, that may be time sensitive and needs to be reflected in a search index 132 quickly. In other embodiments, for example, a “low” priority level 440 may be associated with an indication 410 associated with deletion or removal type events (e.g., such as associated with the deactivation of a website, for example, requiring a large volume of data actions associated with de-indexing or removal of items associated with the website from a search index 132, among other possibilities). Similarly, in some embodiments, for example, the priority level classifier 430 may determine the priority level 440 based on the indication 410 being associated with internal system events. For example, a “low” priority level 440 may be associated with an indication 410 representing CDC backfill events, system maintenance events, system-driven events such as purging of information, bulk operations or other regularly scheduled batch processing, among other possibilities. In this regard, the processing of indications 410 that do not reflect or impact a user experience (e.g., which are not triggered by a user action, or are not perceived by a user as being “fast” or “slow”, among other possibilities) may be processed differently (e.g., according to a different SLO, such as a slower real-time processing timeframe, or using computing resources that have been resourced to reflect the “low” priority level, among other possibilities) than other indications 410 that may directly impact user experience.

In some embodiments, for example, the priority level classifier 430 may determine the priority level 440 for the indication 410 based on a time stamp of the indication 410, for example, where certain priority levels 440 are associated with indications 410 generated by certain event producers 310 compared to indications 410 originating from other producers 310.

In some embodiments, for example, the priority level classifier 430 may provide the corresponding priority level 440 for the indication 410 to the dispatch manager 450, for writing the received indication 410 to the intermediate data store 420. In examples, the intermediate data store 420 may represent a table or a database, for example, a sorted key-value store, among other possibilities. In examples, the dispatch manager 450 may also dispatch the indication 410 to one of the plurality of priority message queues 460, for example, where different priority message queues 460 may use different notification routes for notifying corresponding event consumers 330 when indications 410 require processing. In examples, the plurality of priority message queues 460 may include two or more queues, for example, a prioritized queue(s) and a non-prioritized queue, for receiving the indication 410, based on the corresponding priority level 440. In this regard, the dispatch manager 450 may select a respective one of the plurality of priority message queues 460 for dispatching the received indication 410, for example, based on the respective priority level 440. For example, a priority level 440 indicating that the received indication 410 is a “high”, “medium” or “low” priority event may cause the dispatch manager 450 to select a prioritized queue for dispatching the indication 410, whereas a priority level 440 indicating that the received indication 410 is a “non-priority” event or a system level event (e.g., that may be associated with a scheduled batch process) may cause the dispatch manager 450 to select the non-prioritized queue, respectively. In some embodiments, for example, responsive to writing the indication 410 to the intermediate data store 420, the dispatch manager 450 may generate an update event to a topic corresponding to one of the plurality of priority message queues 460, where each of the plurality of priority message queues 460 may be associated with a different topic.

In examples, the prioritized queue(s) may be associated with one or more event consumers 330. In some embodiments, for example, each prioritized queue may have dedicated event consumers 330. For example, each of the event consumers 330 may be associated with (e.g., subscribed or assigned) to a topic associated with a respective prioritized queue, for example, for receiving notifications when new indications 410 have been dispatched into the respective prioritized queue(s) and are ready to be processed. In this regard, at least one of the plurality of priority message queues 460 may be associated with a target processing timeframe for real-time or near real-time processing. For example, each of the plurality of priority message queues 460 may be associated with a respective service level objective (SLO), such as a real-time processing timeframe (e.g., SLO p50<3 sec, SLO p50<15 sec, SLO p50<30 sec), among other possibilities. In examples, the prioritized queue(s) may include a “high-priority” queue 462, a “medium-priority” queue 464 or a “low-priority” queue 466, among other possibilities. Although the example describes three prioritized queues corresponding to “high”, “medium” and “low” priority levels 440, it is understood that any number of prioritized queues and corresponding priority levels 440 may be used. In other embodiments, the one or more event consumers 330 may act as a resource pool for processing indications of events as they are dispatched into the various prioritized queue(s).

In examples, the non-prioritized queue (e.g., non-priority queue 468) may represent a message queue that is not associated with any real-time or near real-time event consumers 330. For example, the non-priority queue 468 may be a “non-operation” queue, for example, where indications 410 that are dispatched to the non-priority queue are written to the intermediate data store 420 but are not associated with any real-time or near-real time processing by the event consumers 330. For example, indications 410 dispatched into the non-priority queue 468 may be associated with a scheduled batch process, where the scheduled batch processing operation may cause one or more event consumers 330 to read one or more rows in the intermediate data store 420 that are associated with the batch process (e.g., that have been updated within a pre-determined time frame, such as over the past 12 hours, or 24 hours, etc.), among other possibilities. In this regard, the disclosed solution may improve the real-time performance of event-driven systems, by routing the lowest priority events (e.g., “non-priority” level events) to scheduled batch processes, ensuring that the highest priority events are addressed most quickly (e.g., in real-time or near-real-time), and helping to avoiding backlogs caused by bursts of low priority events.

In examples, the one or more event consumers 330 may retrieve the received indication 410 from one of the plurality of priority message queues 460 for processing, for example, to cause the one or more event consumers 330 to perform one or more data actions corresponding to the indication 410. For example, the one or more event consumers 330 may be subscribed to a topic associated with one of the plurality of priority message queues 460, and responsive to being notified of an update event associated with the topic, may read a specific row from the intermediate data store 420 and perform a corresponding data action. In an exemplary embodiment, the one or more event consumers 330 may represent indexing services for generating or maintaining a search index 132, for example, for use with a search engine (e.g., Elasticsearch®), among other possibilities. For example, some data changes that are captured in real-time by a change detection system (e.g., CDC) need to be quickly reflected in a search index 132 (e.g., a full-text search index such as associated with Elasticsearch®) so that applications do not return stale data in response to search queries, while other changes do not need to be reflected in the search index 132 immediately. In this exemplary embodiment, the one or more event consumers 330 may include a real-time indexer 470 or a batch indexer 480 (or multiple real-time indexers 470 and/or batch indexers 480), among other possibilities, and the one or more data actions performed by the event consumers 330 may correspond to an indexing process. In examples, the indications 410 may be retrieved (e.g., consumed) from the plurality of priority message queues 460 by the real-time indexer 470 or the batch indexer 480, for example, according to the corresponding priority level 440. For example, “high”, “medium” or “low” priority changes may be captured in the search index 132 (e.g., associated data records may be re-indexed) by respective one or more real-time indexers 470 while “non-priority” changes may be captured (e.g., re-indexed) by the batch indexer 480, that does not need to process changes in real-time. In this regard, there may be multiple real-time consumers (e.g., real-time indexers 470) consuming update events from their respective priority message queues 460 (e.g., “high-priority” queue 462, “medium-priority” queue 464, “low-priority” queue 466, etc.) and reading from the intermediate store 420, for example, for creating one or more ElasticSearch® documents to index in real-time.

In examples, the real-time indexer 470 and/or the batch indexer 480 may interface with the search index 132 (or alternately, the search engine, not shown) through a connector 490. In examples, the connector 490 may be configured as a bridge between the one or more event consumers 330 and the search index 132, for example, where the connector 490 serves as a temporary data store (e.g., a Kafka® event store, among other possibilities) for storing outputs from the real-time indexer 470 and/or the batch indexer 480 for incorporation into the search index 132. In examples, the search index 132 (or alternately, the search engine) may retrieve the outputs from the real-time indexer 470 and/or the batch indexer 480 (e.g., stored as messages in a queue, among other possibilities) from the connector 490, as the search engine is ready to process the outputs.

In some embodiments, for example, the dispatch manager 450 may interface with the event consumers 330 for dynamically adjusting resource allocation and/or worker allocation (e.g., in a distributed computing environment) for processing the prioritized events dispatched into the priority message queues 460. In examples, the computing devices and/or workers associated with the one or more event consumers 330 which are used for processing the prioritized events may have different levels of available computing resources (e.g., CPU, memory etc.). In this regard, the dispatch manager 450 may interface with the event consumers 330 for managing the work queues of the event consumers 330, for example, via instructions 455, to ensure that higher-priority events are processed by the more performant workers (e.g., having higher CPU count, faster CPU type, more memory, etc) in the worker pool. In other examples, the dispatch manager 450 may interface with the event consumers 330 for dynamically managing and/or scaling the computing resources allocated to each of the event consumers 330, for example, via instructions 455, to ensure the efficient use of overall computing resources. For example, event consumers 330 responsible for processing the indications 410 dispatched to higher-priority queues (e.g., high-priority queue 462, medium-priority queue 464 etc.) may be dynamically re-allocated more resources than other event consumers assigned to processing the indications 410 dispatched to lower priority queues (e.g., low-priority queue 466, non-priority queue 468, etc.), for example, to compensate for increased demand for high-priority (e.g., real-time or near real-time) processing. In this regard, the disclosed solution may promote more efficient operation within a consistent overall resource capacity, by effectively distributing resources according to a priority state of the priority message queues 460 (and accordingly, based on the priority level 440 of the indications 410 dispatched to the priority message queues 460), thereby reducing the need for increasing overall resource capacity to address fluctuations in demand.

In examples, while each of the plurality of priority message queues 460 may be associated with dedicated event consumers 330, during periods of high event volume (e.g., associated with bursts of event generation, such as when a single event causes a plurality of events downstream from the originating event, among other possibilities), the resources associated with these dedicated event consumers 330 may dynamically scale between minimum and maximum resource limits to respond to such fluctuations in demand. For example, dispatch manager 450 may communicate instructions 455 to the event consumers 330 indicating that large volumes of indications 410 are being dispatched into the priority message queues 460. In examples, the event consumers 330 responsible for processing higher priority indications 410 (e.g., associated with the high-priority queue 462, the medium-priority queue 464 etc.) may have a higher maximum resource limit than event consumers 330 responsible for processing lower priority events (e.g., associated with the low-priority queue 466, the non-priority queue 468, etc.). Similarly, event consumers 330 responsible for processing lower priority indications 410 may have a minimum resource limit that is lower than event consumers 330 responsible for processing higher priority indications 410. In some embodiments, for example, the dispatch manager 450 may interface with the event consumers 330 to ensure that, along with auto-scaling the resources associated with event consumers 330, the computing devices and/or workers associated with the dedicated event consumers 330 which are used for processing higher priority events are considered the more performant workers (e.g., having higher CPU count, faster CPU type, more memory, etc) in the worker pool, thereby further improving the processing speed for higher priority indications 410. In examples, the system 300 may use various metrics for managing the allocation of resources, for example, the system 300 may monitor CPU usage metrics, or the system 330 may monitor the number of indications 410 published to a given topic, and/or the number of indications 410 entering a given priority message queue 460, for determining whether the computing resources associated with particular event consumers 330 need to be scaled up or scaled down. In this regard, computing resources may be efficiently allocated according to demand, for processing high and low priority events, thereby improving the performance of event-driven systems, particularly in conditions of high event generation.

In some embodiments, for example, the disclosed solution also provides greater flexibility to configure and/or adjust the priority level 440 of indications 410 during periods of high event volume, for example, the dispatch manager 450 may dynamically and/or temporarily reconfigure the priority level 440 for higher (or medium) priority indications 410, with lower priority levels 440 (or vice versa), for example, to more efficiently manage resource distribution responsive to bursts in event volume. In other examples, the priority level classifier 430 may dynamically and/or temporarily adjust thresholds used in determining the priority level 440 for indications 410, or may adjust other aspects used in determining the priority level 440 for indications 410, in order to more efficiently manage computing resources (e.g., processing power, memory, computing time, etc.) allocated to event consumers 330. For example, responsive to bursts in event volume, the priority level classifier 430 may determine a lower priority level 440 for indications 410 that, under conditions of normal event volumes, would typically be classified with a higher priority level 440, according to the classification scheme and/or priority function 435, for example, as a means of reducing the processing load on event consumers 330 responsible for processing higher priority indications 410 (e.g., by freeing up resources to be allocated to processing higher priority indications 410). In this regard, the system 300 may benefit from greater flexibility in managing the computing resources, thereby ensuring the efficient use of computing resources and improving the performance of event-driven systems, particularly in conditions of high event generation.

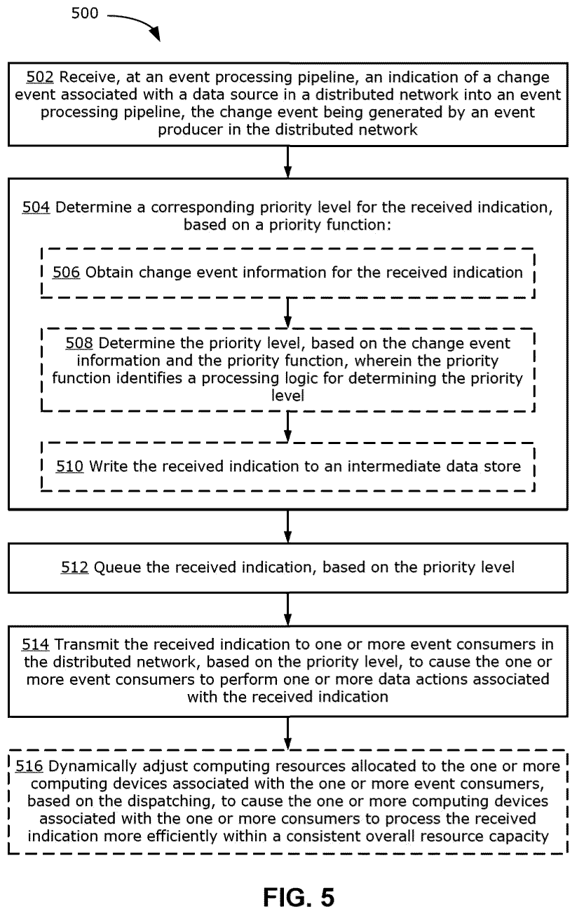

FIG. 5 is a flowchart of an example method 500 for processing change events within the change event dispatching system 300, in accordance with examples of the present disclosure. The method 500 may be performed by the computing system 200. For example, a processing unit of a computing system (e.g., the processor 202 of the computing system 200 of FIG. 2) may execute instructions (e.g., instructions of the change event dispatcher module 320) to cause the computing system to carry out the example method 500.

At an operation 502, an indication 410 of a change event associated with a data source (e.g., associated with data store 130, among other possibilities) in a distributed network (such as the change event dispatching system 300) may be received into a processing pipeline 322. In examples, the processing pipeline 322 may be one of a plurality of processing pipelines 322 of the system 300. In examples, the change event may have been generated by a computing device associated with an event producer 310 in the system 300.

At an operation 504, a priority level 440 for the received indication 410 may be determined, based on a priority function 435. In examples, in determining the priority level 440 for the received indication 410, operations 506-510 may be performed.

At an operation 506, change event information 425 may be obtained for the received indication 410. In examples, the change event information 425 may include information contained in various fields of the received indication 410, such as a source field of the received indication 410 or an identification (ID) field of an entity associated with the change event. In other examples, the change event information 425 may represent one or more characteristics of the change event, for example, a type of change event, an intended destination of the indication 410, a size of an entity and/or data store associated with the change event, or a state of an entity associated with the change event, among other possibilities. In other examples, the change event information 425 may represent a predicted downstream processing load, such as a number of data records that will be affected by processing the indication 410. In some embodiments, for example, the data store 130 may be queried to retrieve the change event information 425 for the received indication 410.

At an operation 508, the priority level 440 may be determined based on the change event information 425 and the priority function 435, wherein the priority function 435 identifies a processing logic for determining the priority level 440. In examples, the priority level 440 may represent a “high”, “medium”, “low” or “non-priority” level, among other possibilities, for example, where a non-priority level may be associated with system-level indications 410 or other indications 410 associated with a scheduled batch process. In examples, at an operation 510, the received indication 410 may be written to an intermediate data store 420.

At an operation 512, the received indication 410 may be queued for processing by the one or more event consumers 330 of the system 300, based on the priority level 440. In examples, queueing the received indication 410 may include dispatching the received indication 410 to a respective one of a plurality of priority message queues 460, based on the priority level 440, for processing by the one or more computing devices associated with the one or more event consumers 330.

At an operation 514, the received indication 410 may be transmitted to one or more computing devices associated with one or more event consumers 330 for processing the received indication 410, according to the priority level 440. In examples, each of the one or more event consumers 330 may subscribe to one of the plurality of priority message queues 460. In examples, transmitting the received indication 410 to the one or more computing devices associated with the one or more event consumers 330 may cause the one or more computing devices associated with one or more event consumers 330 to perform one or more data actions associated with the received indication 410.

At an operation 516, computing resources allocated to the one or more devices associated with the one or more event consumers 330 may be dynamically allocated, based on the dispatching, to cause the one or more devices associated with the one or more event consumers to process the received indication more efficiently within a consistent overall resource capacity. In examples, computing resources may be allocated to computing devices of the event consumers 330 that are subscribed or assigned to one of the priority message queues 460 (e.g., high priority queue 462, among other possibilities), such that higher-priority event indications may be processed more quickly. For example, dynamically allocating computing resources to devices associated with higher priority queues may ensure that ensure that higher-priority event indications are processed by more performant workers in the worker pool. In other examples, dynamically allocating computing resources to devices associated with the priority message queues 460 may represent dynamically scaling the computing resources allocated to each of the event consumers 330 within pre-determined minimum and maximum resource limits to respond to fluctuations in demand, for example, associated with periods of high event generation.

Although the present disclosure describes methods and processes with operations (e.g., steps) in a certain order, one or more operations of the methods and processes may be omitted or altered as appropriate. One or more operations may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A change event dispatching system comprising:
one or more processor devices; and
one or more memories storing machine-executable instructions, which when executed by the one or more processor devices, cause the change event dispatching system to execute operations of a change event dispatcher module, the change event dispatcher module being configured to:
receive an indication of a change event associated with a data source in a distributed network, the change event being generated by a computing device associated with an event producer in the distributed network;
determine a corresponding priority level for the received indication, based on a priority function; and
dispatch the received indication for processing by one or more computing devices associated with one or more event consumers in the distributed network, based on the priority level, to cause the one or more computing devices associated with one or more event consumers to perform one or more data actions corresponding to the indication.

2. The system of claim 1, wherein the change event dispatching system further comprises the computing device associated with the event producer and the one or more computing devices associated with the one or more event consumers.

3. The system of claim 1, further comprising:
a plurality of priority queues, wherein the change event dispatcher module is configured to dispatch the received indication to one of the plurality of priority queues, based on the priority level, and wherein the received indication is processed differently by the one or more event consumers, depending on which one of the plurality of priority queues the indication is dispatched into.

4. The system of claim 3, wherein the change event dispatcher module is further configured to:
select a respective one of the plurality of priority queues for dispatching the received indication, based on the respective priority level.

5. The system of claim 3, wherein at least one of the plurality of priority queues is associated with a target processing timeframe for real-time or near real-time processing.

6. The system of claim 1, further comprising:
a non-priority queue, wherein the change event dispatcher module is configured to dispatch the received indication to the non-priority queue, based on the priority level, for processing by the one or more computing devices associated with the one or more event consumers.

7. The system of claim 6, wherein the non-priority queue is associated with a scheduled batch process.

8. The system of claim 1, wherein the change event dispatcher module is further configured to:
write the received indication to an intermediate data store.

9. The system of claim 8, wherein the change event dispatcher module is configured to determine the priority level for the received indication by:
obtaining change event information for the received indication; and
determining the priority level, based on the change event information and the priority function, wherein the priority function identifies a processing logic for determining the priority level.

10. The system of claim 9, wherein the change event information is selected from a group consisting of: a source field of the received indication, an ID field of the received indication, one or more characteristics of the change event, and a predicted downstream processing load associated with processing the received indication.

11. The system of claim 1, wherein the one or more data actions correspond to an indexing process, and the one or more event consumers includes a real-time indexer or a batch indexer.

12. The system of claim 1, wherein the change event dispatcher module is further configured to:
dynamically adjust computing resources allocated to the one or more devices associated with the one or more event consumers, based on the dispatching, to cause a more efficient operation of the change event dispatching system within a consistent overall resource capacity.

13. A computer-implemented method for processing change events, the method comprising:
receiving, into a processing pipeline, an indication of a change event associated with a data source in a distributed network, the change event being generated by a computing device associated with an event producer in the distributed network;
determining a priority level for the received indication, based on a priority function;
queueing the received indication, based on the priority level; and
transmitting the received indication to one or more computing devices associated with one or more event consumers for processing the received indication, according to the priority level, to cause the one or more computing devices associated with one or more event consumers to perform one or more data actions associated with the received indication.

14. The method of claim 13, wherein queueing the received indication comprises:
dispatching the received indication to a respective one of a plurality of priority queues, based on the priority level, wherein the received indication is processed differently by the one or more event consumers, depending on which one of the plurality of priority queues the indication is dispatched into.

15. The method of claim 14, wherein at least one of the plurality of priority queues is associated with a target processing timeframe for real-time or near real-time processing.

16. The method of claim 13, wherein queueing the received indication comprises:
dispatching the received indication to a non-priority queue, based on the priority level, for processing by the one or more computing devices associated with the one or more event consumers.

17. The method of claim 16, wherein the non-priority queue is associated with a scheduled batch process.

18. The method of claim 1, wherein determining the priority level for the received indication comprises:
obtaining change event information for the received indication; and
determining the priority level, based on the change event information and the priority function, wherein the priority function identifies a processing logic for determining the priority level.

19. The method of claim 1, further comprising:
dynamically adjusting computing resources allocated to the one or more computing devices associated with the one or more event consumers, based on the dispatching, to cause the one or more computing devices associated with the one or more event consumers to process the received indication more efficiently within a consistent overall resource capacity.

20. A non-transitory computer-readable medium storing instructions that, when executed by a processing unit of a computing system, cause the computing system to:
determine a priority level for a received indication of a change event associated with a data source in a distributed network, based on a priority function, the change event being generated by a computing device associated with an event producer in the distributed network;
queue the received indication, based on the priority level; and
transmit the received indication to one or more computing devices associated with one or more event consumers for processing the received indication, according to the priority level, to cause the one or more computing devices associated with one or more event consumers to perform one or more data actions associated with the received indication.
